(19) United States
(12) Patent Application Publication
(10) Pub. No.: US 2006/0292321 A1
(43) Pub. Date: Dec. 28, 2006

(54) Decorative polymeric multilayer structures

(76) Inventor: Christophe Chervin, Neydens (FR)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/451,062

(22) Filed: Jun. 12, 2006

Related U.S. Application Data
(60) Provisional application No. 60/690,282, filed on Jun. 14, 2005.

(51) Int. Cl. C03C 17/32

(52) U.S. Cl. 428/34.6

(57) ABSTRACT

Decorative polymeric multilayer structures are made by melt bonding thermoplastics to the two sides of an irregularly surfaced sheet, at least one side of which has printing on it, decorative and/or informative. The thermoplastic bonded to the printed side of the sheet is transparent. The resulting structure may be part of various types of labeled or otherwise marked items such as jars, bottles, jar and bottle caps, sporting goods, electronic, etc., and also is useful as decorative panels.

This application claims the benefit of U.S. Provisional Application No. 60/690,282, filed Jun. 14, 2005.

### FIELD OF THE INVENTION

Decorative polymeric multilayer structures comprise polymeric layers, one of which is an irregularly surfaced polymeric sheet which is printed on at least one surface, a transparent polymeric material melt bonded to the printed surface, and another polymeric material which is melt bonded to the other surface of the irregularly surfaced polymeric sheet.

### BACKGROUND OF THE INVENTION

Thermoplastic polymers (TPs) are important items of commerce, many different types (chemical compositions) and blends thereof being produced for a myriad of uses. In many instances it is desired to use more than one type of polymer and to “decorate” the polymer with various designs and/or information. This is often a complicated and expensive operation, since different polymers do not adhere well to one another, and many polymers are difficult to print because various types of ink do not adhere well to many polymers.

For example it is well known that almost all TPs are highly incompatible with one another, and finding an effective adhesive or compatibilizing agent is often daunting, and simply melt bonding to each other almost always doesn't work (little or no bond strength is obtained). Thus in many instances simple and inexpensive methods of bonding different TPs are often not available.

In addition to using combinations of TPs to improve specific combinations of properties, sometimes decorative surfaces such as labels or architectural panels are preferably protected against degradation, for example from light, abrasion, water, and other ambient conditions.

U.S. Pat. No. 4,892,779 describes a multilayer article formed by fusion bonding a microporous polyolefin layer of a specified composition with a nonporous material such as a TP. While printing of the microporous layer is described, no mention is made of protecting the printed layer with a transparent thermoplastic overlayer melt bonded to the printed label.

Nonwoven fabrics (NWFs) have also been used to bond other materials together, such as wood and polyethylene, see for instance U.S. Pat. No. 6,136,732 in which a NWF is impregnated with a powdered adhesive which is then bonded to the NWF by melting the adhesive. This sheet may be used to bond “vinyl and/or cloth covering and a variety of surfaces including metal, plastic, rubber and wood.” by melting the adhesive on the NWF. However there is no specific mention of bonding two TPs together.

U.S. Pat. No. 6,544,634 contains an example (Example 19) in which a rubber is “fused” to the surface of a microporous sheet, this assembly is placed into an injection mold with the uncoated side of the microporous sheet exposed, and propylene is injection molded into the mold. While printing of the microporous layer is described, no mention is made of protecting the printed layer with a transparent thermoplastic overlayer which is melt bonded.

U.S. Patent Application Publication 2005/0003721 describes the adhesion of two different thermoplastics polymers by melt bonding them to an irregularly surfaced polymer sheet (ISS). No mention is made of the ISS being printed, nor of it being then melt bonded on the printed side to a transparent thermoplastic.

### SUMMARY OF THE INVENTION

This invention concerns an article comprising a multilayer structure thermoplastic or crosslinked thermoset resin sheet having a first side and a second side and having printing on at least one of said first side or second side, a first thermoplastic melt bonded to said first side of said sheet, and a second thermoplastic melt bonded to said second side of said sheet, and

provided that:
said first side and said second side have irregular surfaces; and
said first thermoplastic is transparent.

This invention also concerns a process for forming a multilayer structure, comprising:
(a) melt bonding a first thermoplastic to a first side of a sheet comprising a crosslinked thermoset or thermoplastic resin; and
(b) melt bonding a second thermoplastic to a second side of said sheet;

and provided that:
said first side and said second side have irregular surfaces;
said first thermoplastic is transparent; and
there is printing on at least one of said first or second sides of said sheet.

### DETAILED DESCRIPTION OF THE INVENTION

The following definitions are provided as reference in accordance with how they are used in the context of this specification and the accompanying

“Sheet” means a material shape in which two of the surfaces have at least about twice, more preferably at least about 10 times, the surface areas of any of the other exterior surfaces. Included in this definition would be a sheet with the dimensions 15 cm×15 cm×0.3 cm thick, and a film 15 cm×15 cm×0.2 mm thick. The latter (which is often called a film) in many instances will be flexible and may be drapeable, so that is can be adapted to conform to irregular surfaces. Preferably the sheet has a minimum thickness of about 0.03 mm, more preferably about 0.08 mm, and especially preferably about 0.13 mm. Preferably the sheet has a maximum thickness of about 0.64 mm, more preferably about 0.38 mm, and especially preferably about 0.25 mm. It is to be understood that any preferred minimum thickness can be combined with any preferred maximum thickness to form a preferred thickness range.

“Irregular surface” means that the surface has irregularities in or on it that will aid in mechanically locking to it any molten material which flows into or onto the surface and the irregularities thereon, and when the molten material subsequently solidifies it causes the material to be mechanically locked (i.e. bonded) to the irregular surface.

“Resin” means any polymeric material, whether of natural or manmade (synthetic) origin. Synthetic materials are preferred.

“Irregular surface sheet (ISS)” means a sheet having an “irregular surface”.

“Melt bonding” means the TP is melted where “melted” means that a crystalline TP is heated to about or above its highest melting point, while an amorphous thermoplastic is melted above its highest glass transition temperature. While melted the TP is placed in contact with an appropriate surface of the ISS. During this contact, usually some pressure (i.e. force) will be applied to cause the TP to flow onto and perhaps penetrate some of the pores or irregularities on the surface of the ISS. The TP is then allowed to cool, or otherwise become solid.

“Thermoplastic” (TP) is material that is meltable before and while being melt bonded to the ISS, but in their final form are solids, that is they are crystalline or glassy (and therefore typical elastomers, whose melting points and/or glass transition temperature, if any, are below ambient temperature, are not included in TPs, but thermoplastic elastomers are included in TPs). Thus this can mean a typical (i.e. “classical”) TP polymer such as polyethylene. It can also mean a thermosetting polymer before it thermosets (e.g. crosslinks), that is, while it can be melted and flows in the molten state. Thermosetting may take place after the melt bonding has taken place, perhaps in the same apparatus where the melt bonding took place, and perhaps by simply further heating of the thermoset resin, to form a resin which is glassy and/or crystalline. Useful thermoplastic elastomers include block copolyesters with polyether soft segments, styrene-butadiene block copolymers, and thermoplastic polyurethanes.

By TPs being “different” is meant that they have a different chemical composition. Examples of different thermoplastics include: polyethylene (PE) and polypropylene; polystyrene and poly(ethylene terephthalate) (PET); nylon-6,6 and poly(1,4-butylene terephthalate; nylon-6,6 and nylon-6; polyoxymethylene and poly(phenylene sulfide); poly(ethylene terephthalate) and poly(butylene terephthalate); poly(ether-ether-ketone) and poly(hexafluoropropylene)(perfluoromethyl vinyl ether) copolymer); a thermotropic liquid crystalline polyester and a thermosetting epoxy resin (before crosslinking); and a thermosetting melamine resin (before crosslinking) and a thermosetting phenolic resin (before crosslinking). Different thermoplastics may also include blends of the same thermoplastics but in different proportions, for example a blend of 85 weight percent PET and 15 weight percent PE is different than a blend of 35 weight percent PET and 65 weight percent PE. Also, different includes differing in the presence and/or amount of other comonomers, for example PET is different than poly(ethylene isophthalate/terephthalate). Although they may be the same (especially when both sides of the ISS are printed), preferably the first and second TPs are different.

“Bonded” herein is meant the materials are attached to one another, in most instances herein permanently, and/or with the ISS between the materials. Typically no other adhesives or similar materials are used in the bonding process, other than the ISS.

The ISS sheet may have irregular surfaces formed in many ways. It may be: a fabric, for instance woven, knitted or nonwoven; a paper; foamed, particularly an open cell foam and/or a microcellular foam; a sheet with a roughened surface formed by for example sandblasting or with an abrasive such as sandpaper or sharkskin; and a microporous sheet (MPS). Preferred forms of ISS are fabrics, especially nonwoven fabrics (NWFs), and microporous sheets (MPSs).

“Microporous” means a material, usually a thermoset or thermoplastic polymeric material, preferably a thermoplastic, which is at least about 20 percent by volume, more preferably at least about 35% by volume pores. Often the percentage by volume is higher, for instance about 60% to about 75% by volume pores. The porosity is determined according to the equation:
“Porosity”=100(1−d₁/d₂)
wherein d₁ is the actual density of the porous sample determined by weighing a sample and dividing that weight by the volume of the sample, which is determined from the sample's dimensions. The value d₂ is the “theoretical” density of the sample assuming no voids or pores are present in the sample, and it determined by known calculations employing the amounts and corresponding densities of the sample's ingredients. More details on the calculation of the porosity may be found in U.S. Pat. No. 4,892,779, which is hereby incorporated by reference. Preferably the microporous material has interconnecting pores.

The MPS herein may be made by methods described in U.S. Pat. Nos. 3,351,495, 4,698,372, 4,867,881, 4,874,568, and 5,130,342, all of which are hereby included by reference. A preferred microporous sheet is described in U.S. Pat. No. 4,892,779, which is hereby included by reference. Similar to many microporous sheets those of this patent have a high amount of a particulate material (filler). This particular type of sheet is made from polyethylene, much of which is a linear ultrahigh molecular weight polymer.

“Fabric” is a sheet-like material made from fibers. The materials from which the fibers are made may be synthetic (man-made) or natural. The fabric may be a woven fabric, knitted fabric or a nonwoven fabric, and nonwoven fabrics are preferred. Useful materials for the fabrics include cotton, jute, cellulosics, wool, glass fiber, carbon fiber, poly(ethylene terephthalate), polyamides such as nylon-6, nylon-6,6, and aromatic-aliphatic copolyamides, aramids such as poly(p-phenylene terephthalamide), polypropylene, polyethylene, thermotropic liquid crystalline polymer, fluoropolymers and poly(phenylene sulfide).

The fabric herein can be made by any known fabric making technique, such as weaving or knitting. However a preferred fabric type is a NWF. NWFs can be made by methods described in I. Butler, The Nonwoven Fabrics Handbook, Association of the Nonwoven Fabrics Industry, Cary, N.C., 1999, which is hereby included by reference. Useful types of processes for making NWFs for this invention include spunbonded, and melt blown. Typically the fibers in the NWF will be fixed in some relationship to each other. When the NWF is laid down as a molten TP (for example spunbonded) the fibers may not solidify completely before a new fiber layer contacts the previous fiber layer thereby resulting in partial fusing together of the fibers. The fabric may be needled or spunlaced to entangle and fix the fibers, or the fibers may be thermally bonded together.

The characteristics of the fabric to some extent determines the characteristics of the bond(s) between the TPs to be joined. Preferably the fabric is not so tightly woven that melted TP has difficulty (under the melt bonding condition used) penetrating into and around the fibers of the fabric. Therefore it may be preferable that the fabric be relatively porous. However, if the fabric is too porous it may form bonds which are too weak. The strength and stiffness of the fabric (and in turn the fibers used in the fabric) may determine to some extent the strength and other properties of the bond(s) formed. Higher strength fibers such as carbon fiber or aramid fibers therefore may be advantageous in some instances.

By “decorated” or “decorative” is meant that the item has visible on it decorations such as pictures, coloration or patterns, and/or have text such as descriptions, trademarks, instructions (for use), advertising, etc., which is visible by simple visual observation to an individual.

By “transparent” in herein is meant an underlying surface which is decorated (printed) is visible through that particular (transparent) material, in the thickness used. Visible in this context means that any purely decorative patterns are visible, and/or text may be reasonably easily read. Thickness is a variable because in a very thick layer a material may not be transparent enough, but in a thinner layer is transparent enough to meet the above criterion. The transparent material may be colored, as by dyes, as long as it meets the requirements for transparency.

By “multilayer” is meant a structure contains two or more, preferably three or more layers. For instance structure that contained a first TP layer melt bound to a printed, which in turn was melt bound to a second TP would be a three layer structure. It would still be three layers if both the first and second TPs were identical. The ink from printing of the ISS is not considered a layer herein.

Without being held to theory, it is believed that the thermoplastics may bond to the surfaces of the ISS sheet (at least in part) by mechanical locking of the TP to the ISS sheet. It is believed that during the melt bonding step the TP “penetrates” the irregularities on the surface, or actually below or through the surface through pores, voids and/or other channels (if they exist). When the TP solidifies, it is mechanically locked into and/or onto these irregularities and, if present, pores, voids and/or other channels.

One type of preferred material for the first and/or second TP is a “classical TP”, that is a material that is not easily crosslinkable, and which has a melting point and/or glass transition temperature above about 30° C. Preferably, if such a classical TP is crystalline, it has a crystalline melting point of 50° C. or more, more preferably with a heat of fusion of 2 J/g or more, especially preferably 5 J/g or more. If the TP is glassy it preferably has a glass transition point of 50° C. or more. In some instances the melting point or glass transition temperature may be so high that the TP decomposes before reaching that temperature. Such polymers are also included herein as TPs.

Such classical TPs include: poly(oxymethylene) and its copolymers; polyesters such as PET, poly(1,4-butylene terephthalate), poly(1,4-cyclohexyldimethylene terephthalate), and poly(1,3-poropyleneterephthalate); polyamides such as nylon-6,6, nylon-6, nylon-12, nylon-11, and aromatic-aliphatic copolyamides; polyolefins such as polyethylene (i.e. all forms such as low density, linear low density, high density, etc.), polypropylene, polystyrene, polystyrene/poly(phenylene oxide) blends, polycarbonates such as poly(bisphenol-A carbonate); fluoropolymers including perfluoropolymers and partially fluorinated polymers such as copolymers of tetrafluoroethylene and hexafluoropropylene, poly(vinyl fluoride), and the copolymers of ethylene and vinylidene fluoride or vinyl fluoride; polysulfides such as poly(p-phenylene sulfide); polyetherketones such as poly(ether-ketones), poly(ether-ether-ketones), and poly(ether-ketone-ketones); poly(etherimides); acrylonitrile-1,3-butadinene-styrene copolymers; thermoplastic (meth)acrylic polymers such as poly(methyl methacrylate); thermoplastic elastomers such as the “block” copolyester from terephthalate, 1,4-butanediol and poly(tetramethyleneether)glycol, and a block polyolefin containing styrene and (hydrogenated) 1,3-butadiene blocks; and chlorinated polymers such as poly(vinyl chloride), vinyl chloride copolymer, and poly(vinylidene chloride). Polymers which may be formed in situ, such as (meth)acrylate ester polymers are also included. Any of the types of TPs in this listing may be used with any other type of TP in this listing in the process structure described herein. In one form herein, it is preferred that one or both of the first and second TPs are classical TPs.

Useful thermosettable (i.e. readily crosslinkable) TPs include epoxy resins, melamine resins, phenolic resins, thermosetting polyurethane resins, and thermosetting polyester resins. These thermosetting resins may be combined with any of the specific TP resins or resin types listed above. In one preferred form of the invention these thermosettable resins are both the first and second TPs. In another preferred form of the invention one of the first and second TPs is a thermosettable resin and the other is a classical TP.

At least the first TP must be transparent, although both the first and second TPs may both be transparent. Some of the classical TPs mentioned above and some of the thermosettable TPs mentioned above may be transparent, for example polyesters; polyamides; polyolefins; polycarbonates; fluoropolymers; acrylonitrile-1,3-butadiene-styrene copolymers; thermoplastic (meth)acrylic polymers such as poly(methyl methacrylate); and chlorinated polymers such as poly(vinyl chloride). Many of these types of TPs are often translucent or opaque because they are highly crystalline, but in copolymer form crystallinity may be reduced to the point that for the present purposes they are transparent. Specific useful transparent classical TPs include poly(methyl methacrylate), ionomeric copolymers of ethylene, (meth)acrylic acid and optionally (meth)acrylate esters (available from E. I. DuPont de Nemours & Co., Inc, Wilmington, Del. 19898, USA under the tradename Surlyn®), polycarbonates, and “amorphous” polyamides. If crystalline polymers are quenched very rapidly from the melt their crystallites tend to be less numerous and/or smaller, and they are more transparent, so more highly crystalline polymers, when quenched, may be transparent. Also relatively crystalline polymers may be transparent enough if the layer thickness is small.

Many thermosettable TPs, such as epoxy resins, are also transparent.

The ISS is printed on at least one side, although both sides may be printed. When both sides are printed it is preferred that both the first and second TPs are transparent.

Printing of the ISS may be carried out by many “normal” printing processes adapted to handle the ISS physically. Of course the ink used should have reasonable adhesion to the ISS although strong adhesion may not be needed since the printed side of the ISS will eventually be “protected” by the first TP. Printing processes are well known in the art, see for instance. M. Larsen, Industrial Printing Ink, Reinhold Publishing Corp. (1962), Encyclopedia of Chemical Technology, 2^{nd} Ed., John Wiley & Sons, Inc., Vol. 11, p. 611-632 (1966), and Vol. 16, p. 494-546 (1968), and R. N. Blair, The lithographers Manual, The Graphic Arts Technical Foundation, Inc., 7^{th} Ed. (1983), and U.S. Pat. No. 4,892,779. An especially useful form of printing is ink-jet printing.

It is preferred that whatever the printing method used that the ink does not completely “smooth” or fill in the ISS surface because adhesion of the first TP after melt bonding may be reduced if the surfaced is smooth. Preferred ISSs to be printed are MPS and NWF, and MPS is especially preferred. An especially preferred form of MPS is described in U.S. Pat. No. 4,892,779, which is hereby included by reference.

More than two TP layers may be assembled with the printed ISS, so long as an ISS is used between each of the different types of TPs to form a bond, and the additional layers (including the ISS) are bonded to the second TP layer. For example sheets of three different TPs may be bonded together by placing an ISS between each of the TP sheets, and then (melt) laminating the assembly to form melt bonds between the TPs and the ISSs. This may be carried out, for example, by heated calendar rolls of a belt press. The lamination of each TP to an ISS surface may be any combination of sequential or simultaneous heat bonding.

The melt bonding may be carried out in a number of ways. For instance, the unprinted side of the ISS may be placed against one side of an injection mold and the first TP injection molded into the mold so that it melt bonds to the printed side of the ISS. After the first TP has solidified, the part containing the first TP may be removed and placed into a second mold (the same mold may be used if it has a cavity with variable thickness) where the other surface of the ISS is exposed and the second TP injected into that mold to melt bond to the exposed ISS surface. The order of injecting the first and second TPs may also be reversed. After solidification of the second TP the bonded part may be removed from the mold. This process may be used with thermally crosslinkable resin(s) and the part held in a hot mold until the(ose) resin(s) crosslink (i.e. thermoset). In a variation of this process different polymers may be injection molded simultaneously onto the two surfaces of the ISS which is held in place in the mold. The ISS may be held in the proper position in the mold by a variety of known techniques such as vacuum, electrostatic charges, mechanically, adhesive (tape), etc.

In another process, the ISS may be laminated onto a surface of the first and/or second TP. If the first TP is used, it should be laminated onto the printed surface of the ISS. For example, roll lamination may be used to bond the first and second TPs onto the surfaces of the ISS. This may be done sequentially or simultaneously, and is particularly useful when the first and/or second TPs are sheets and/or films. Hot roll(s) calendering and/or a belt calendar may be used.

In another process, a compression mold is filled with the first TP and the ISS is laid on top of the first TP with the printed side contacting the first TP, or is against one side of the mold. The mold is closed and heated (or is already hot) and pressure is applied. The second TP may then be contacted to the other surface of the ISS in a similar manner. Alternatively, the first TP is added to the mold, and the (printed side of) ISS is placed on top (or to the side of it) and the second TP is added so it will contact the other surface of the ISS. The mold is then closed and pressure is applied.

In another process, films of different TPs may be placed on either side of an ISS (with the first TP on the printed side) and then the assembly placed in a thermoforming machine wherein the TP films are adhered “through” the sheet, and a thermoformed shaped product is also produced. Multiple layers of TPs and ISSs may be employed in this and other similar processes, particularly those which use TP films.

Any combination of the above methods may be used. For example, the first TP may be laminated onto the printed surface of the ISS, and then the second surface of the ISS is melt bonded to the second TP in an injection molding or compression molding process. Other combinations will be obvious to the artisan.

In the melt bonding process it is preferred that the rough surface features, whatever they are, of the ISS are not usually totally destroyed, and are often left fairly intact. For instance if the ISS comprises a TP, and temperature of the melt bonding process results in that TP being melted, the irregularities of the ISS may be lost. This may be avoided by a number of methods. The temperatures needed to cause the first and second TPs to melt may be low enough so that the melting point (if any) and/or the glass transition point of any TP comprising the ISS is higher than the melt bonding process temperature. Another method for avoiding loss of surface irregularities is for the ISS to be made from a crosslinked thermoset resin or another material with a high melting point, such as a metal. If the ISS comprises a TP, in some instances the TP may be so viscous that it flows little if at all above the melting/glass transition temperature. The viscosity can be increased by using a large amount filler, and/or using a TP which has a very high molecular weight, such as ultrahigh molecular weight polyethylene. For example, in one type of preferred ISS, preferably MPS, made from a thermoplastic, it is preferred that the thermoplastic have a weight average molecular weight of about 500,000 or more, more preferably about 1,000,000 or more. One useful type of TP which can be obtained in such high molecular weights is polyethylene, and it is a preferred TP for the ISS, preferably MPS. Another method to prevent the loss of rough surface features when bonding (a) TP(s) with higher melting points or glass transition temperatures is to minimize the time of exposure of the ISS to higher temperatures, so that the TP(s) “penetrate” the rough surface in a short period of time, which is not enough time for heat transfer to cause loss of the rough surface. Some of these methods may be combined to further retard loss of surface irregularities in the ISS.

Once the bonded structure is formed, in many instances the bonded interfaces are not the weak point in the structure. That is in many instances attempts to peel the two TPs from each other (TPs in the sense of during the melt bonding process) results in cohesive failure of one of the TPs or ISS, illustrating that material's inherent strength is the weak point of the bonded assembly.

The polymers described herein, either the TPs and/or the polymers of the ISS, but particularly the TPs, may contain materials normally found in such polymers, for example, fillers, reinforcing agents, antioxidants, pigments dyes, flame retardants, etc., in the amounts that are normally used in such compositions. However the first TP should remain transparent.

The multilayer structures of the present invention are useful in many applications, such as bottles, jars, bottle and jar caps, electronic equipment, sporting goods, kitchenware, and decorative panels for architectural or appliance uses. In all cases the printed surface, which may be strictly decorative and/or informative (particularly with text), or show a trademark, is protected by the layer of first TP. This protection may be from abrasion, scratching, light (UV and/or visible light absorber may be present in the first TP for instance), water, etc. Depending on the protection needed the first TP may be appropriately chosen. The first TP may also be chosen to given a certain “feel” to the item, for example a softer TP (perhaps one with plasticizer) may allow a softer feel to the surface and perhaps even enhance the ability to grip the surface, as for a bottle cap. The ISS provides a good surface on which to print and also provides a means of joining different TPs. The second TP (and other additional layers if present) may provide properties such as physical strength, toughness, resistance to diffusion of substances (in both directions), chemical resistance, and/or other desirable properties.

Examples of specific types of uses are:
Warning and/or informational labels on appliances, electronics, medical devices, and power tools.
Protected tradnames and/or Trademarks on various items such as sporting goods, shoes, electronics, cosmetics, perfumes and appliances.
Decorative and/or informational labels on containers for items such as cosmetics, pharmaceuticals, perfumes, household chemicals (detergents, cleaners, etc.), agricultural chemicals, and foods.
Decorative panels for interior (and in some cases exterior) use such as for countertops, paneling, and tabletops.

One of the TP layers may be a barrier resin such as the Selar® barrier resins available from E. I. DuPont de Nemours and Co., Inc., Wilmington, Del. 19898, USA. Thus a somewhat permeable resin such as polyethylene may be bonded to a barrier resin using an ISS to make the part less permeable to certain materials such as water or oxygen. This may be useful in containers such as bottles, jars, tanks, carboys, drums, and similar items. The barrier resin may be bonded to the inside or outside of the container, or may be an intermediate layer.

### EXAMPLES

Melting points and glass transition temperatures described herein were measured using ASTM Method D3418. Melting points were taken as the maximum of the melting endotherm, and glass transition temperatures were taken as the midpoint of the transition. Melting points and glass transition temperatures were measured on a second heat.

In the Examples, the following abbreviations and materials are used:
Delrin® 500P—a medium viscosity acetal homopolymer available from E. I. duPont de Nemours and Company, Wilmington, Del., USA.
PP—Adflex® Q300F, available from Basell BV, 2130 AP Hoofddorp, Netherlands, is a polyolefin copolymer, and is believed to be a propylene copolymer.
Surlyn® PC2000—an ethylene/methacrylic acid copolymer which is partially neutralized by sodium ions (and hence is an ionomer), available from E. I. duPont de Nemours and Company, Wilmington, Del., USA.
Teslin® SP700—A 0.18 mm thick microporous sheet containing high molecular weight polyethylene and large amounts of precipitated silica available from PPG Industries, Pittsburgh, Pa., USA (a similar suitable material may be available under the tradename MiST®).
Teslin® SP1000—A 0.25 mm thick microporous sheet containing high molecular weight polyethylene and large amounts of precipitated silica available from PPG Industries, Pittsburgh, Pa., USA (a similar suitable material may be available under the tradename MiST®).

### Example 1

Printing Procedure—For all of the Examples the Teslin® SP700 or SP1000 was printed on one side using a Hewlett-Packard Deskjet® 5740 inkjet printer. The patterns printed, such as a Tartan plaid or tiger stripe-like pattern were overall patterns, that is the whole surface of the Teslin® was printed. The Teslin® was cut in sheets the size of A4 paper to be printed. The inks used were from Hewlett-Packard, the reference numbers being 343-C8766E (three color) and 339-C8767E (black).

Molding Procedure—An Engel 1750 injection molding machine (Engel Austria, GmbH, A1130 Vienna, Austria) with a 40 mm screw was used. A 100×100 mm plaque mold, which could be adjusted for thickness, was used. The printed Teslin® sheet with the printed side against the mold surface, was inserted into the mold and held there with adhesive tape. Then either the PP or Delrin® 500P was injection molded so that a plaque 100×100 mm×2 mm thick was produced. One surface of this plaque was the printed side of the Teslin® sheet.

This 2 mm thick plaque was then placed back inside the mold (now set for a 5 mm overall thickness) with the printed Teslin® sheet surface against a surface of the mold. Then Surlyn® PC2000 (in this case it is the “first TP”) was injected into the mold. Injection molding conditions for all polymer are given in Table 1.

TABLE 1

| | | | Surlyn ® |
|---|---|---|---|
| Polymer | PP | Delrin ® 500P | PC2000 |
| Barrel temp, ° C. | 200 | 215 | 200 |
| Injection time, s | 5.7 | 5.5 | 5.7 |
| Hold pressure, | 70 | 90 | 100 |
| MPa | | | |
| Hold time, s | 20 | 25 | 25 |
| Cooling time, s | 15 | 15 | 20 |
| Total cycle, s | 55 | 55 | 59.4 |

Four combinations of ingredients were used—Delrin®, Teslin® SP700, Surlyn®; Delrin®, Teslin® SP1000, Surlyn®; PP, Teslin® SP700, Surlyn®; and PP, Teslin® SP1000, Surlyn®. In all cases the resulting plaques were 5 mm thick, about a 2 mm thick PP or Delrin® layer and about a 3 mm thick Surlyn® layer. The pattern printed on the Teslin® clearly visible without apparent distortion. Adhesion appeared to be good, since the layers could not be separated by hand. When the same procedure was carried out without the Teslin® layer, the two TP layers essentially fell apart (had no adhesion).

What is claimed is:

1. An article comprising: a multilayer structure thermoplastic or crosslinked thermoset resin sheet having a first side and a second side and having printing on at least one of said first side or second side, a first thermoplastic melt bonded to said first side of said sheet, and a second thermoplastic melt bonded to said second side of said sheet, and
provided that:
said first side and said second side have irregular surfaces; and
said first thermoplastic is transparent.

2. The article as recited in claim 1 wherein said sheet is a microporous sheet.

3. The article as recited in claim 1 wherein said sheet is a fabric.

4. The article as recited in claim 1 wherein one or both of said first and second thermoplastics are classical thermoplastics.

5. The article as recited in claim 4 wherein said classical thermoplastics are selected from the group consisting of poly(oxymethylene) and its copolymers, polyesters, polyamides, polyolefins, polystyrene/poly(phenylene oxide) blends, polycarbonates, fluoropolymers, polysulfides, polyetherketones, poly(etherimides), acrylonitrile-1,3-butadinene-styrene copolymers, thermoplastic (meth)acrylic polymers, thermoplastic elastomers, and chlorinated polymers.

6. The article as recited in claim 1 wherein said first side has printing and both said first and second thermoplastics are transparent.

7. The article as recited in claim 1 wherein both first and second sides of said sheet have printing.

8. The article as recited in claim 1 which is or is part of a bottle, jar, bottle or jar cap, electronic equipment, sporting good, kitchenware, or decorative panels for architectural or appliance uses.

9. The article as recited in claim 1 which comprises a warning and/or informational label, a label comprising a tradename and/or trademark, or a decorative label.

10. The article as recited in claim 1 additionally comprising a barrier layer.

11. A process for forming a multilayer structure, comprising:
(a) melt bonding a first thermoplastic to a first side of a sheet comprising a crosslinked thermoset or thermoplastic resin; and
(b) melt bonding a second thermoplastic to a second side of said sheet;
and provided that:
said first side and said second side have irregular surfaces;
said first thermoplastic is transparent; and
there is printing on at least one of said first or second sides of said sheet.

12. The process as recited in claim 11 wherein said sheet is a microporous sheet.

13. The process as recited in claim 11 wherein said sheet is a fabric.

14. The process as recited in claim 11 wherein one or both of said first and second thermoplastics are classical thermoplastics.

15. The process as recited in claim 11 wherein one or both of steps (a) and (b) are carried out in an injection mold.

16. The process as recited in claim 11 wherein one or both of steps (a) and (b) are carried out by roll lamination.

17. The process as recited in claim 11 wherein one or both of steps (a) and (b) are carried out in a compression mold.

18. The process as recited in claim 11 wherein one or both of steps (a) and (b) are carried out by thermoforming.
